(19) United States
(12) Patent Application Publication
(10) Pub. No.: US 2005/0116065 A1
(43) Pub. Date: Jun. 2, 2005

(54) Water distributor for various spraying devices

(76) Inventor: Tsai Chen Yang, Taichung (TW)

Correspondence Address: Tsai Chen Yang, P.O. Box 63-99, Taichung, 406, TW

(21) Appl. No.: 10/727,014

(22) Filed: Dec. 1, 2003

(51) Int. Cl. A62C 31/00

(52) U.S. Cl. 239/443; 239/444; 239/446; 239/447

(57) ABSTRACT

A water distributor includes a housing having an inlet for receiving water, and having two or more openings formed in a peripheral wall, for coupling to two or more water outlet members. A valve member is rotatably received in the housing, and includes an orifice to receive the water, and a side aperture for selectively aligning with either of the openings of the housing, and to allow the water to flow out through either of the water outlet members. The valve member includes a spring-biased plug to engage with the housing. An anchor member may be attached to the housing, to rotatably retain the valve member in the housing.

### BACKGROUND OF THE INVENTION

1. Field of the Invention

The present invention relates to a water distributor, and more particularly to a water distributor for attaching to such as bathrooms, and for selectively coupling to various spraying devices.

2. Description of the Prior Art

Typically, in bathrooms, one or more shower heads are provided and coupled to a faucet which may control the water to selectively flow out through the shower heads.

However, the faucet may not be coupled to the other spraying devices, and thus may not supply water to the other spraying devices.

The present invention has arisen to mitigate and/or obviate the afore-described disadvantages of the conventional water distributors.

### SUMMARY OF THE INVENTION

The primary objective of the present invention is to provide a water distributor for attaching to such as bathrooms, and for selectively coupling to various spraying devices.

In accordance with one aspect of the invention, there is provided a water distributor comprising a housing including a bore formed therein and defined by an inner peripheral surface, and an inlet communicating with the bore thereof, for coupling to a water reservoir, and for receiving water from the water reservoir, the housing including a peripheral wall having a first opening and at least one second opening formed therein and communicating with the bore thereof, a first water outlet member coupled to the first opening of the housing, at least one second water outlet member coupled to the second opening of the housing, and a valve member rotatably received in the bore of the housing, and including an orifice formed therein and communicating with the inlet of the housing, for receiving water from the inlet of the housing, and including a side aperture formed therein and communicating with the orifice thereof, for selectively directing toward and aligning with either of the first opening or the second opening of the housing, and to allow the water to flow out through either of the first water outlet member or the second water outlet member.

The valve member includes a plug received in the side aperture of the valve member, for engaging with the inner peripheral surface of the housing. The valve member further includes a spring for biasing the plug to engage with the inner peripheral surface of the housing. The plug includes a peripheral recess formed therein for receiving the spring. The plug includes a peripheral bulge extended outwardly therefrom, to engage into the side aperture of the valve member, and to force-fit the plug in the side aperture of the valve member.

An anchor member may further be provided and attached to the housing, to rotatably retain the valve member in the bore of the housing.

The housing includes a peripheral fence having a notch formed therein, the anchor member includes a jut extended therefrom and engaged into the notch of the housing, to position the anchor member to the housing, and to prevent the anchor member from being rotated relative to the housing.

The anchor member includes a plurality of depressions formed therein, the valve member includes a spring biased projection to selectively engage into either of the depressions of the anchor member, and to position the valve member relative to the anchor member.

A barrel may further be provided and attached to the housing and including a peripheral flange extended inwardly therefrom, to engage with the anchor member, and to stably retain the anchor member and the valve member within the bore of the housing. The valve member includes a stem extended therefrom, and a knob attached to the stem, to rotate the stem and the valve member relative to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view illustrating a water distributor in accordance with the present invention for coupling to various spraying devices;

FIG. 2 is a partial exploded view of the water distributor;

FIG. 3 is another partial exploded view of the water distributor;

FIG. 4 is a cross sectional view of the water distributor;

FIG. 5 is a cross sectional view taken along lines 5-5 of FIG. 2;

FIGS. 6, 7 are cross sectional views taken along lines 6-6, and 7-7 of FIG. 3 respectively,

FIG. 8 is a plan view of an anchor member of the water distributor; and

FIG. 9 is a cross sectional view taken along lines 9-9 of FIG. 8.

### DETAILED DESCRIPTION OF THE PREFERRED EMBODIMENT

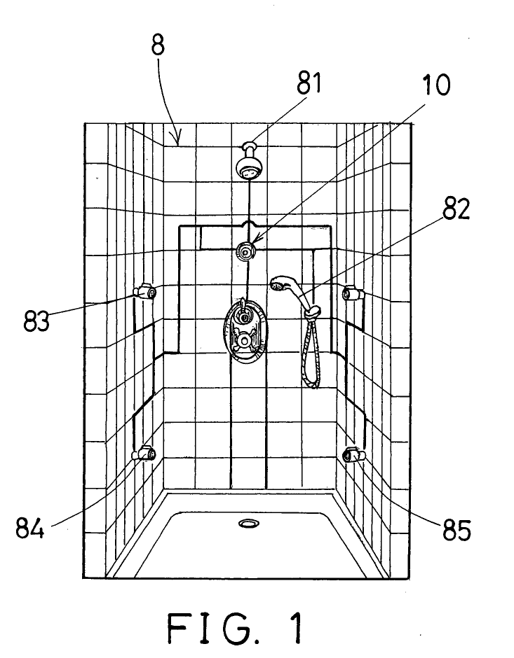

Referring to the drawings, and initially to FIG. 1, a water distributor in accordance with the present invention is generally indicated with a reference numeral “10” and is attached to such as a bathroom 8, for coupling to such as a fixed water outlet member 81 or a shower head 81, a portable or movable water outlet member 82 or a shower head 82, and various water outlet member or faucets or spraying devices 83, 84, 85, for selectively distributing water through either of the shower heads 81, 82 or the spraying devices 83, 84, 85.

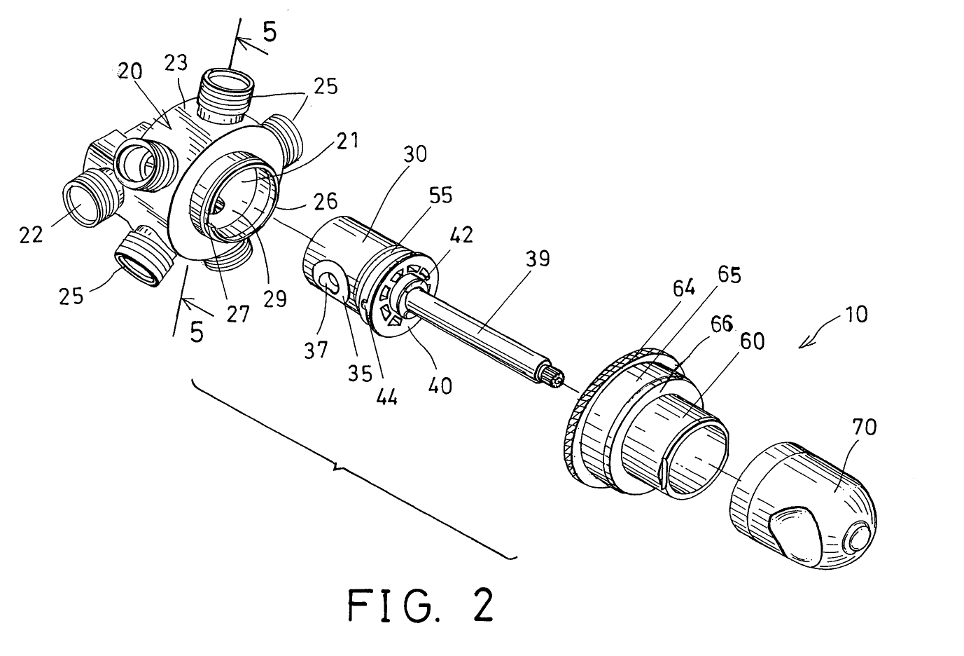

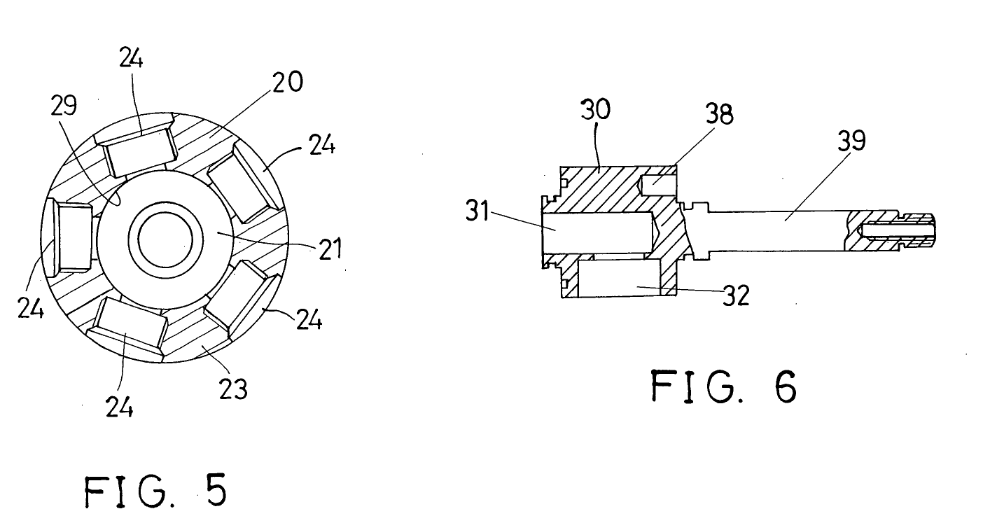

Referring next to FIGS. 2-5, the water distributor 10 comprises a housing 20 including a bore 21 formed therein and defined by an inner peripheral surface 29, and an inlet 22 communicating with the bore 21 thereof, for coupling to a water reservoir, and for receiving water from the water reservoir. The housing 20 includes a peripheral wall 23 having two or more openings 24 formed therein, and preferably equally spaced from each other, and communicating with the bore 21 thereof.

Two or more fittings or couplers 25 are attached to the openings 24 of the housing 20 respectively, for coupling the shower heads 81, 82 and the spraying devices 83, 84, 85 to the openings 24 of the housing 20 respectively. The housing 20 includes a peripheral fence 26 extended upwardly therefrom, and having a notch 27 formed therein.

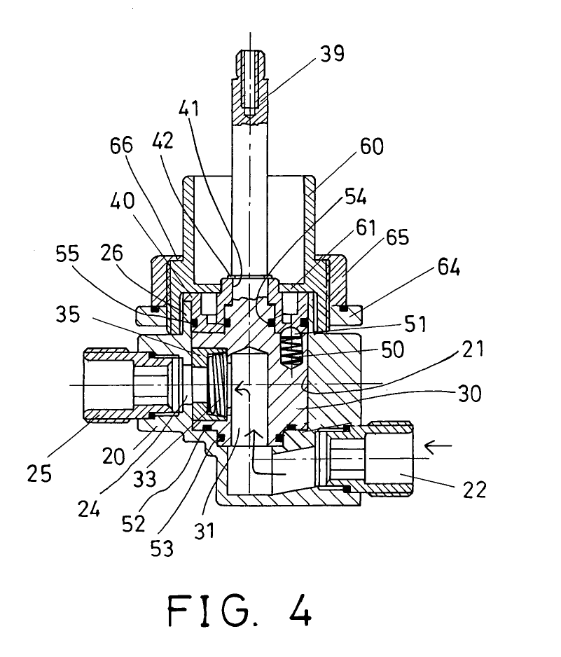

As shown in FIGS. 2, 3, 4, 6, a valve member 30 is rotatably received in the bore 21 of the housing 20, and includes an orifice 31 formed therein, and an aperture 32 formed in the side portion thereof and communicating with the orifice 31 thereof, for receiving water from the inlet 22 of the housing 20, best shown in FIG. 4. A spring 33 and a gasket 34 and a plug 35 are received in the aperture 32 of the valve member 30.

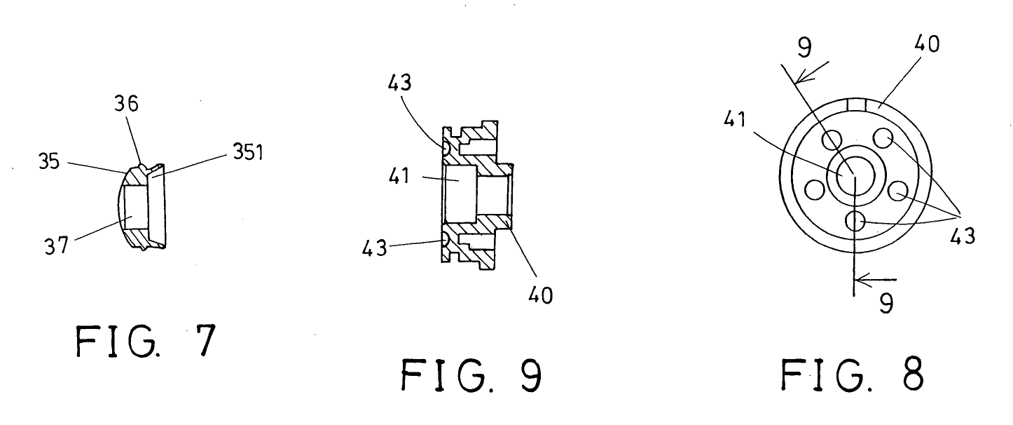

As best shown in FIG. 7, the plug 35 is preferably made of rubber or synthetic materials, and includes a peripheral bulge 36 extended radially and outwardly therefrom, for engaging into the aperture 32 of the valve member 30, and for allowing the plug 35 to be force-fitted within the aperture 32 of the valve member 30. The plug 35 includes a bore 37 formed therein, and a peripheral recess 351 formed therein for receiving or seating the spring 33.

In operation, as shown in FIG. 4, the plug 35 may be biased and forced against the inner peripheral surface 29 of the housing 20 by the spring 33, for allowing the plug 35 to be snugly fitted or engaged onto or against the inner peripheral surface 29 of the housing 20, and thus for making a water tight seal between the plug 35 and the valve member 30 and the housing 20, and for preventing the water from flowing through the contact portion between the plug 35 and the inner peripheral surface 29 of the housing 20.

The plug 35 or the aperture 32 of the valve member 30 may be directed toward or aligned with either of the openings 24 of the housing 20 when the valve member 30 is rotated relative to the housing 20, for allowing the water to be selectively distributed or supplied to either of the shower heads 81, 82 or the spraying devices 83, 84, 85, via either of the openings 24 of the housing 20.

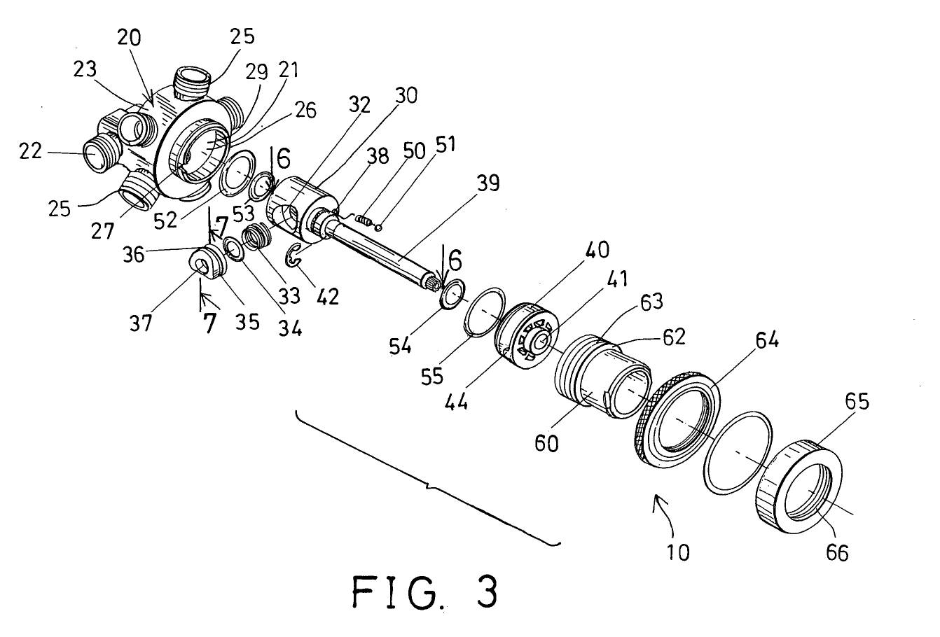

The valve member 30 includes a cavity 38 formed therein (FIGS. 3, 6), to receive a spring 50 and a ball or projection 51 which may be biased by the spring 50. The valve member 30 further includes a stem 39 extended therefrom. One or more sealing rings 52, 53 may be engaged between the valve member 30 and the housing 20 (FIGS. 3, 4), for making a water tight seal between the valve member 30 and the housing 20.

As shown in FIGS. 2-3 and 8-9, an anchor member 40 includes a bore 41 formed therein to rotatably receive the stem 39 of the valve member 30, and thus for allowing the stem 39 of the valve member 30 to be rotated relative to the anchor member 40. The anchor member 40 may be rotatably secured onto the stem 39 of the valve member 30 with such as a retaining ring 42.

The anchor member 40 further includes two or more depressions 43 formed therein, to selectively receive the spring biased projection 51 (FIG. 4), and thus to position the valve member 30 to the anchor member 40 at selected or predetermined angular positions. The anchor member 40 further includes a jut 44 extended therefrom and engaged into the notch 27 of the housing 20 (FIG. 2), to position the anchor member 40 to the housing 20, and to prevent the anchor member 40 from being rotated relative to the housing 20.

The anchoring or securing of the anchor member 40 to the housing 20 may be used to stably and rotatably retain the valve member 30 within the bore 21 of the housing 20, and may be arranged to allow the plug 35 and the aperture 32 of the valve member 30 to be suitably directed toward or aligned with either of the openings 24 of the housing 20.

One or more sealing rings 54 may be engaged between the valve member 30 and the anchor member 40 (FIGS. 3, 4), for making a water tight seal between the valve member 30 and the anchor member 40, and one or more sealing rings 55 may be engaged between the housing 20 and the anchor member 40 (FIGS. 3, 4), for making a water tight seal between the housing 20 and the anchor member 40.

A casing or a barrel 60 may be secured onto the housing 20, such as threaded to the peripheral fence 26 of the housing 20, and includes a peripheral flange 61 extended radially and inwardly from the middle portion thereof (FIG. 4), to engage with the anchor member 40, and thus to stably retain the anchor member 40 and thus the valve member 30 within the bore 21 of the housing 20.

The barrel 60 includes a peripheral bulge 62 and an outer thread 63 formed on the outer peripheral portion thereof, a lock nut 64 and a cap 65 may be threaded onto the outer thread 63 of the barrel 60. The cap 65 includes a peripheral flange 66 extended inwardly therefrom, to engage with the peripheral bulge 62 of the barrel 60, and thus to secure the barrel 60 and the cap 65 together.

A knob 70 may be secured to the stem 39 of the valve member 30, for rotating the stem 39 of the valve member 30 relative to the anchor member 40 and the housing 20, and thus for aligning or directing the plug 35 and the aperture 32 of the valve member 30 toward either of the openings 24 of the housing 20.

In operation, the valve member 30 may be rotated relative to the anchor member 40 and the housing 20 with the knob 70, to suitably align or direct the plug 35 and the aperture 32 of the valve member 30 toward either of the openings 24 of the housing 20, and thus to allow the water to be selectively distributed or supplied to either of the shower heads 81, 82 or the spraying devices 83, 84, 85, via either of the openings 24 of the housing 20.

The spring biased projection 51 of the valve member 30 may be biased and engaged into either of the depressions 43 of the anchor member 40, to position the valve member 30 to the anchor member 40 and thus to the housing 20 at selected or predetermined angular positions, and to maintain the plug 35 and the aperture 32 of the valve member 30 in suitable alignment with either of the openings 24 of the housing 20.

Accordingly, the water distributor in accordance with the present invention may be attached to such as bathrooms, and for selectively coupling to various spraying devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A water distributor comprising:
a housing including a bore formed therein and defined by an inner peripheral surface, and an inlet communicating with said bore thereof, for coupling to a water reservoir, and for receiving water from the water reservoir, said housing including a peripheral wall having a first opening and at least one second opening formed therein and communicating with said bore thereof,
a first water outlet member coupled to said first opening of said housing,
at least one second water outlet member coupled to said at least one second opening of said housing, and
a valve member rotatably received in said bore of said housing, and including an orifice formed therein and communicating with said inlet of said housing, for receiving water from said inlet of said housing, and including a side aperture formed therein and communicating with said orifice thereof, for selectively directing toward and aligning with either of said first opening or said at least one second opening of said housing, and to allow the water to flow out through either of said first water outlet member or said at least one second water outlet member.

2. The water distributor as claimed in claim 1, wherein said valve member includes a plug received in said side aperture of said valve member, for engaging with said inner peripheral surface of said housing.

3. The water distributor as claimed in claim 2, wherein said valve member further includes a spring for biasing said plug to engage with said inner peripheral surface of said housing.

4. The water distributor as claimed in claim 3, wherein said plug includes a peripheral recess formed therein for receiving said spring.

5. The water distributor as claimed in claim 2, wherein said plug includes a peripheral bulge extended outwardly therefrom, to engage into said side aperture of said valve member, and to force-fit said plug in said side aperture of said valve member.

6. The water distributor as claimed in claim 1 further comprising an anchor member attached to said housing, to rotatably retain said valve member in said bore of said housing.

7. The water distributor as claimed in claim 6, wherein said housing includes a peripheral fence having a notch formed therein, said anchor member includes a jut extended therefrom and engaged into said notch of said housing, to position said anchor member to said housing, and to prevent said anchor member from being rotated relative to said housing.

8. The water distributor as claimed in claim 6, wherein said anchor member includes a plurality of depressions formed therein, said valve member includes a spring biased projection to selectively engage into either of said depressions of said anchor member, and to position said valve member relative to said anchor member.

9. The water distributor as claimed in claim 6 further comprising a barrel attached to said housing and including a peripheral flange extended inwardly therefrom, to engage with said anchor member, and to stably retain said anchor member and said valve member within said bore of said housing.

10. The water distributor as claimed in claim 1, wherein said valve member includes a stem extended therefrom, and a knob attached to said stem, to rotate said stem and said valve member relative to said housing.
